(19) United States
(12) Patent Application Publication
(10) Pub. No.: US 2024/0054867 A1
(43) Pub. Date: Feb. 15, 2024

(54) PRODUCTS HAVING MULTI-PURPOSE INDICATORS USABLE BY MULTIPLE DIFFERENT SYSTEMS

(71) Applicant: IGT Global Solutions Corporation, Providence, RI (US)

(72) Inventors: Paul Riley, East Greenwich, RI (US); Nicholas G. Fazzano, Providence, RI (US); Anthony Lucci, North Kingstown, RI (US); Thomas Oram, Hudson, MA (US); Jennifer Seymour, Woodstock, GA (US)

(21) Appl. No.: 17/819,068

(22) Filed: Aug. 11, 2022

(51) Int. Cl. G07F 17/32; G06K 7/14; G06Q 50/34

(52) U.S. Cl. CPC G07F 17/329; G06K 7/1413; G06Q 50/34

(57) ABSTRACT

Products such as instant lottery tickets, pull-tabs, coupons, and gift cards including multi-purpose indicators that function with multiple different systems to enable activation, validation, purchase, use, and/or redemption by such multiple different systems.

### BACKGROUND

The present disclosure relates to products having multi-purpose indicators and related systems that enable activation, validation, purchase, use, and/or redemption of such products by multiple different devices and systems.

Instant lottery tickets have substantial variations in the structures, configurations, and arrangements of the individual components of inventory control or identifying numbers for such instant lottery tickets. These variations occur on a jurisdictional basis and on a manufacturer basis. This wide variety of the structures, configurations, and arrangements of the individual components of the inventory control or identifying numbers for instant lottery tickets limits the types of systems that can be used to activate, validate, sell, manage, and redeem such instant lottery tickets.

Today, many instant lottery tickets have inventory control or identifying numbers in the form of two barcodes that are visible on the back of each ticket and include: a UPC (or EAN) barcode and a lottery specific barcode. Having a plurality of barcodes with their respective encapsulated data can require multiple barcode readings to capture the inherent data and results in more labor costs and potential errors. For example, the deciding which barcode to scan automatically increases the time of a transaction for an employee who is new to an organization.

### BRIEF SUMMARY

In various embodiments, the present disclosure relates to a product including a substrate having a front surface and a back surface and a multi-purpose indicator on one of the front surface and the back surface. The multi-purpose indicator includes a product identifier indicator set, a barcode type indicator set, a specification version indicator set, a jurisdiction identifier indicator set, an UPC/EAN indicator set, a game/promotion number indicator set, a pulse number indicator set, a book number indicator set, a ticket number indicator set, and a check digits indicator set.

In various other embodiments, the present disclosure relates to an instant lottery ticket product including a substrate having a front surface and a back surface, the front surface of including a predefined scratch-off area, variable lottery game indicia printed on the predefined scratch-off area, a scratch-off-coating covering the variable lottery game indicia, and a multi-purpose indicator in a machine-readable format on the back surface of the substrate. The multi-purpose indicator includes a product identifier indicator set, a barcode type indicator set, a specification version indicator set, a jurisdiction identifier indicator set, an UPC/EAN indicator set, a game/promotion number indicator set, a pulse number indicator set, a book number indicator set, a ticket number indicator set, and a check digits indicator set.

In various other embodiments, the present disclosure relates to a product including a substrate having a front surface and a back surface, and a multi-purpose indicator on one of the front surface and the back surface. The multi-purpose indicator includes a product identifier indicator set, a barcode type indicator set, a specification version indicator set, a jurisdiction identifier indicator set, an UPC/EAN indicator set, a game/promotion number indicator set, a pulse number indicator set, a book number indicator set, a ticket number indicator set, and a check digits indicator set. For this product, one of the jurisdiction identifier indicator set, the game/promotion number indicator set, the book number indicator set, and the ticket number indicator set are not relevant to the product.

Additional features are described in, and will be apparent from, the following Detailed Description and the figures.

### BRIEF DESCRIPTION OF THE SEVERAL VIEWS OF THE DRAWINGS

FIG. 1A is a front view of an example known type of single game instant lottery ticket

FIG. 1B is a rear view of the example known type of single game instant lottery ticket of FIG. 1A.

FIG. 2A is a front view of an example known type of multi-game instant lottery ticket.

FIG. 2B is a rear view of the example known type of multi-game instant lottery ticket of FIG. 2A.

FIG. 3 is fragmentary rear view of an example known type of instant lottery ticket showing variable instant lottery ticket information printed on the back surface of the instant lottery ticket.

FIG. 4 is a top perspective view of a plurality of different example instant lottery ticket books on a platform.

FIG. 5 is a diagrammatic view of parts of a structure for instant lottery tickets and related data files.

FIG. 6 shows a series of different example multi-purpose indicators of one example embodiment of the present disclosure, and that are configured for lottery ticket products.

FIG. 7 is a table showing the individual indicator sets that form the multi-purpose indicators of FIG. 6.

FIGS. 8A, 8B, and 8C are different example multi-purpose indicators corresponding to the multi-purpose indicators of FIG. 6 and that are in machine readable form.

FIG. 9A is a front view of an example single game instant lottery ticket of one example embodiment of the present disclosure.

FIG. 9B is a rear view of the example single game instant lottery ticket of FIG. 9A.

FIG. 10 is a table showing the individual indicator sets that form the multi-purpose indicators for a gift card of another example embodiment of the present disclosure and an example of such multi-purpose indicator in human readable form.

FIG. 11 is a table showing the individual indicator sets that form the multi-purpose indicators for a coupon of another example embodiment of the present disclosure and an example of such multi-purpose indicator in human readable form.

### DETAILED DESCRIPTION

In various embodiments, the present disclosure relates generally to products having multi-purpose indicators and related systems that enable activation, validation, purchase, use, and/or redemption of products by multiple different devices and systems. The multi-purpose indicators additionally eliminate the need to: either physically scan multiple codes (such as multiple barcodes) on such products using one system or scan one code (such as one barcode) on such products using multiple systems. In various embodiments, the products can be instant lottery tickets, pull-tabs, coupons, gift cards, or other similar products.

For ease of understanding the present disclosure, instant lottery tickets are employed herein as a primary example of a product; however, it should be appreciated that the present disclosure is not meant to be limited by such examples. Additionally, for a better understanding of the present disclosure, example known products in the form of instant lottery tickets (and related instant lottery ticket books and instant lottery ticket systems) are first described herein.

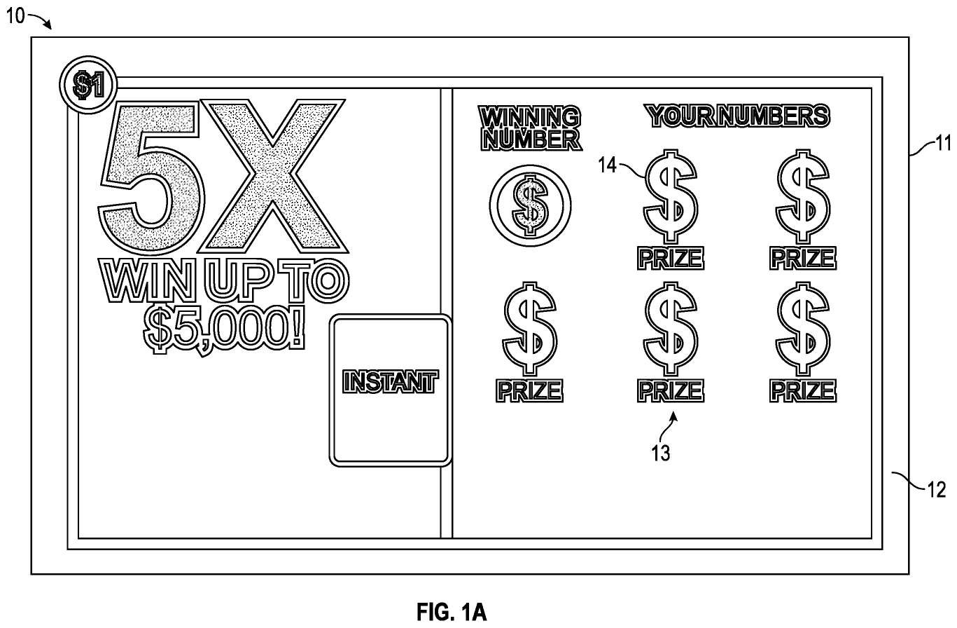

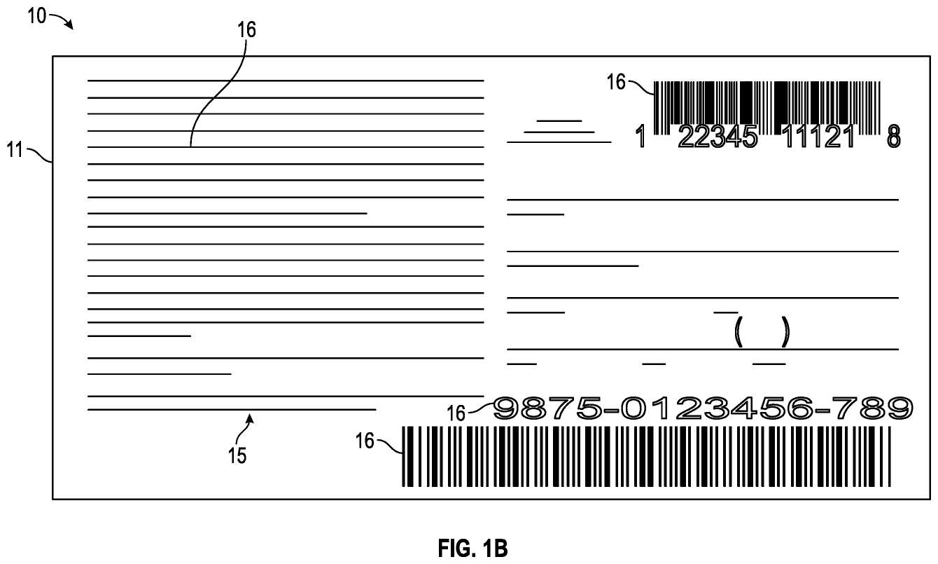

Various known instant lottery tickets are single game instant lottery tickets. An example single game instant lottery ticket is illustrated in FIGS. 1A and 1B. This example single game instant lottery ticket 10 includes: (1) a ticket substrate 11; (2) a front surface 12 of the ticket substrate 11; (3) a predefined scratch-off area 13 defined on the front surface 12; (4) a scratch-off coating (“SOC”) 14 covering variable lottery game indicia (not shown) printed on the predefined scratch-off area 13; (6) a back surface 15 of the ticket substrate 11; and (7) variable instant lottery ticket information indicia 16 printed on the back surface 15. The instant lottery ticket information indicia 16 can include text, one or more ticket numbers, one or more ticket barcodes, and other instant lottery ticket information that is in either or both human readable and machine readable. Although not shown, such instant lottery tickets can also include redemption related barcodes under the SOC that are used for facilitating redemption of such lottery tickets. Certain of the instant lottery ticket information identifies the instant lottery ticket, the set, run, or book of instant lottery tickets that this instant lottery ticket is/was part of, and can provide other inventory control information. Various known single game instant lottery tickets can include multiple predefined scratch-off areas, multiple sets of variable lottery game indicia printed on the predefined scratch-off areas, and multiple SOCs covering the variable lottery game indicia sets and codes (such as barcodes).

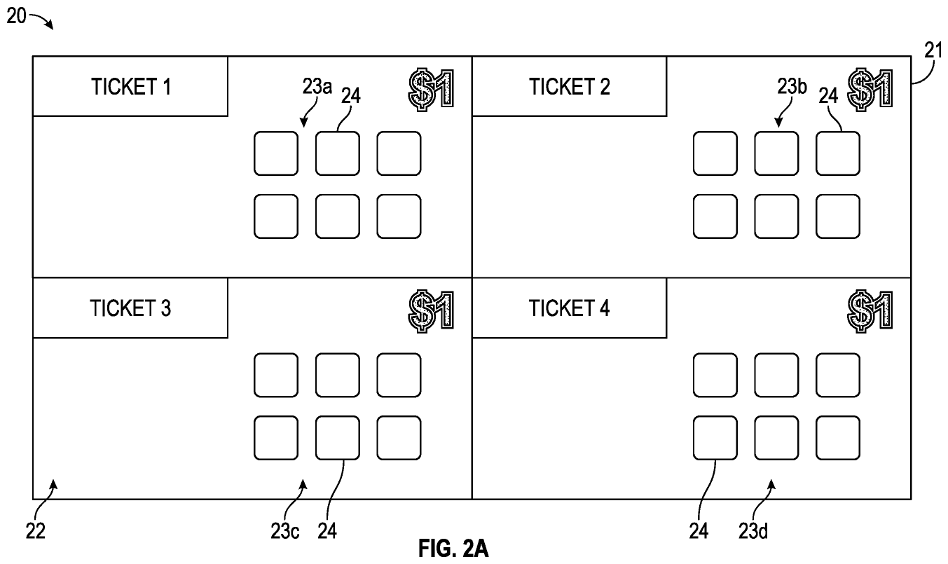

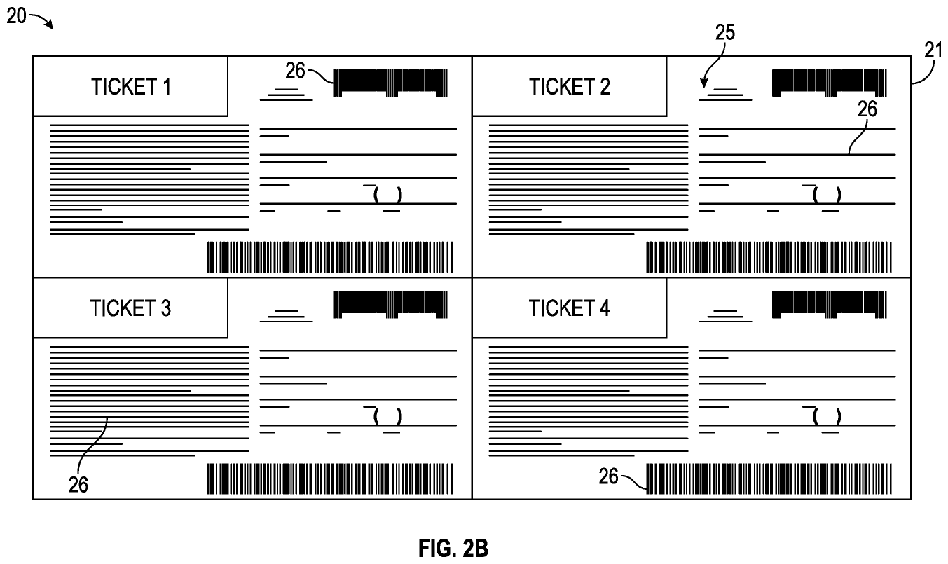

Various known known instant lottery tickets are multi-game instant lottery tickets. One example multi-game instant lottery ticket is illustrated in FIGS. 2A and 2B. This example multi-game instant lottery ticket 20 includes four separate games. This example multi-game instant lottery ticket 20 includes: (1) a ticket substrate 21; (2) a front surface 22 of the ticket substrate 21; (3) four predefined scratch-off areas 23a, 23b, 23c, and 23d defined on the front surface 22 (and including one area for each game); (4) four scratch-off coatings 24 covering the respective lottery game indicia (not shown) printed in each of the predefined scratch-off areas 23a, 23b, 23c, and 23d; (5) a back surface 25 of the ticket substrate 21; and (6) four sets of variable instant lottery ticket information indicia 26 printed on the back surface 25. The instant lottery ticket information indicia 26 can include text, ticket numbers, ticket barcodes, and other instant lottery ticket information that is either or both human readable and machine readable. Although not shown, such instant lottery tickets can also include redemption related barcodes under the SOCs that are used for facilitating redemption of such lottery tickets. Certain of this information identifies the instant lottery ticket, the set, run, or book of instant lottery tickets that this instant lottery ticket is/was part of, and can provide other inventory control information. These known multi-game game instant lottery tickets thus include multiple predefined scratch-off areas, multiple sets of variable lottery game indicia printed on the predefined scratch-off areas, and multiple SOCs covering the variable lottery game indicia sets.

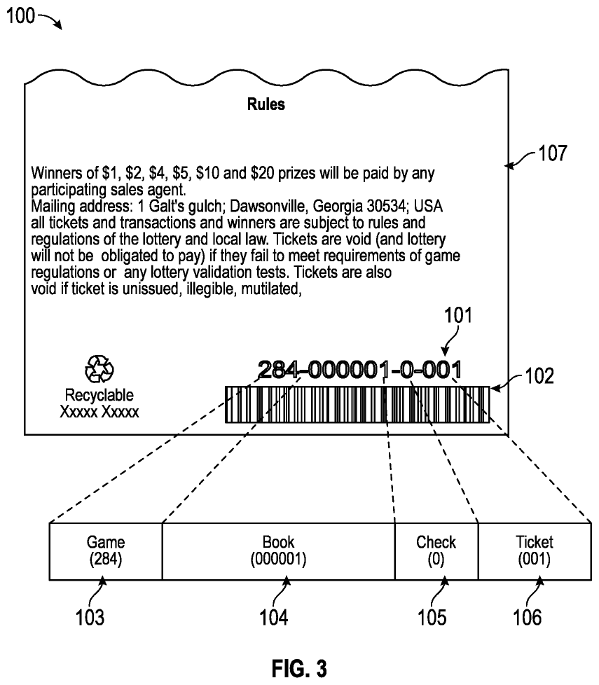

FIG. 3 depicts part of an example of one known type of instant lottery ticket including a variable human readable inventory control number 101, associated machine-readable barcode 102, and legal text 107 printed on the instant lottery ticket back 100. FIG. 3 shows the components of the instant ticket's human readable inventory control number's 101 data that includes: (1) a three-digit game identifying number 103, (2) a six-digit book number 104, (3) a one-digit check number 105, and (4) a three-digit ticket number 106, that together uniquely identify this instant lottery ticket from a book of instant lottery tickets (described in more detail below). The instant ticket's barcode 102 represents corresponding identical data. All of this data in both machine and human readable formats specifically only provide limited information regarding the instant lottery ticket. The instant ticket inventory control data 103, 104, 105, and 106 on the back of the instant lottery ticket 100 are readable prior to purchase of the instant lottery ticket. This readability enables warehouse storage, picking, shipping, book activation, by sale, and redemption of such instant lottery ticket. For security reasons, many lotteries have removed win or loss related information from this visible barcode and placed such information (or information that leads a lottery system to such information) under an SOC. While the instant ticket's barcode 102 can be scanned and decoded by certain barcode reading devices, unless those devices are connected to a lottery's instant ticket management system, the device (such as a retail point of sale systems) cannot use the information. Additionally, the length and positioning of inventory and validation information and check digit is non-uniform and varies from jurisdiction to jurisdiction, which makes it very difficult for barcode reading devices to determine how to read the data and parse it. Furthermore, since there are often two separate barcodes on a lottery ticket that are geographically separated on that lottery ticket, and which typically have different barcode formats and encode different data, such configurations can require significantly more effort to read all the required data, especially on a high-volume basis.

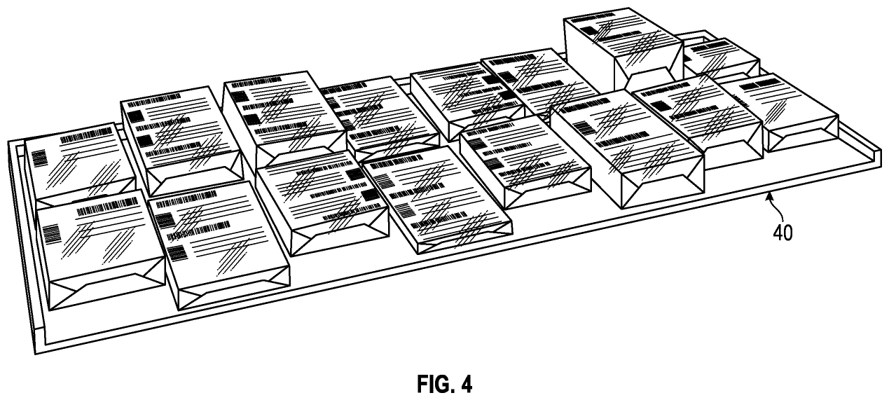

Instant lottery tickets are typically arranged during manufacture (which includes after complete printing) in instant lottery ticket books of a static quantity that typically varies by price point for storage, for organization, for sorting, for picking, and for shipping to instant lottery ticket seller (such as instant lottery ticket retailers). Examples of different instant lottery ticket books (not labeled) are shown in FIG. 4 positioned face down on a platform 90. The instant lottery ticket books often include: (1) a stack of instant lottery tickets (that are all of the same type, same size, and same game(s)); and (2) a transparent secure outer wrapping (such as transparent plastic wrapping) around the stack of instant lottery tickets. Such instant lottery ticket books are typically configured such that the back surface of at least one instant lottery ticket is visible through the transparent book wrapping. Instant lottery ticket books for different games often have tickets of a different size and different quantities of tickets in the book and thus have different book dimensions (e.g., length, width, and/or height). All the books of a single instant lottery game contain the same quantity of tickets and have the book dimensions. Like many consumer products, it is possible for an instant ticket lottery game to be produced with books of tickets arranged in more than one configuration. For example, a lottery might want 50 tickets in a book of $30 tickets for use in self-service vending machine and 20 tickets in a book for retailers who sell the game without using a self-service vending machine.

Logistical tracking and activation of such instant lottery tickets are accomplished by grouping tickets together in books such as shown in FIG. 4. There are several reasons for arranging instant lottery tickets in books. One reason is that instant lottery tickets can be ordered and shipped in books with the book being the fundamental unit of reconciliation. Since instant lottery tickets are shipped in books, the book is also the fundamental unit of activation on the overall instant lottery ticket system. In other words, individual instant lottery ticket activation is currently done on the book level instead of the individual ticket level. When a retailer receives a new book of instant lottery tickets, the retailer must first activate the book on the instant lottery ticket system before selling any of the instant lottery tickets in that book. Book activation thereby enables instant lottery tickets to be shipped via common carrier since un-activated or stolen instant lottery ticket books can be flagged on the instant lottery ticket system with any instant lottery ticket in that book designated as invalid if redemption of that instant lottery ticket is attempted.

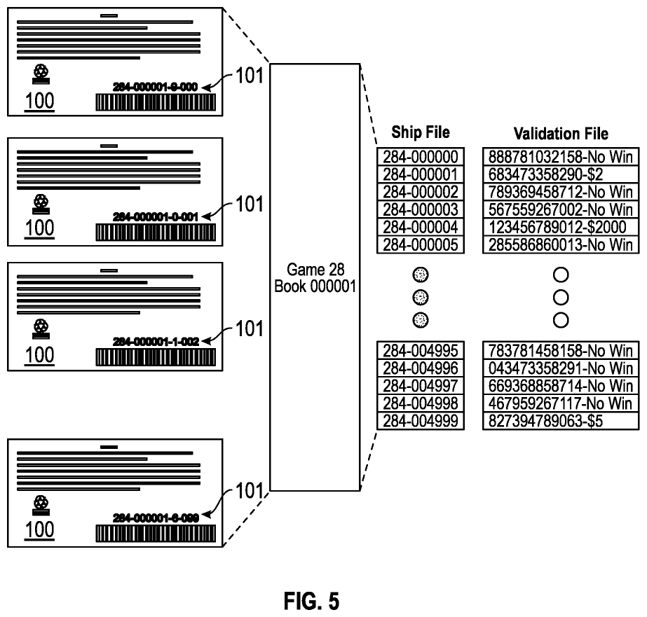

As further shown in FIG. 5, all of the books for a given lottery game are logged in a digital ship file by the instant lottery ticket manufacturer and loaded on the instant lottery ticket system prior to the game being placed on sale. The ship file contains a listing of all the manufactured books identifying (typically by omission) any book numbers that were destroyed in the manufacturing process. The inventory file for a game is transferred from the ticket manufacturer and loaded into a lottery's instant ticket management system. As a lottery game is placed on sale, the instant ticket system collects information such as: “book ‘X’ shipped to retailer ‘Y’”, and then “book ‘X’ was activated”, or “book ‘X’ was reported as stolen/missing”, etc. Thus, the ship file enables logistical tracking of all manufactured books in an instant lottery ticket game. The ship file does not contain any win or lose information and cannot be linked to a validation file.

The validation file contains the validation codes for all instant lottery tickets for a lottery game. The validation codes provide pointers to the prize values (if any) of the instant lottery tickets on the instant lottery ticket system. The validation codes are inaccessible on un-played or unsold instant lottery tickets due to a portion of the code being covered by SOC. In some versions, the validation code is also embodied in a barcode hidden under the SOC such that it cannot be scanned until the instant lottery ticket is scratched to expose the barcode, and in other versions there is some validation file information in addition to the inventory control information in the ticket back barcode 102 in an encrypted format. Therefore, the security of the system is derived from the validation file being unassociated with the ship file as well as the physical un-played ticket's inventory control information. Both the ship and validation files are generated by the ticket manufacturer before the tickets are shipped to a lottery. Lottery logistical and validation systems require the ship and validation files to be loaded on the lottery system prior to instant tickets being shipped to retailers and placed on sale. Once loaded onto the system, the basic validation file typically cannot be altered (other than flagged additions—e.g., redeemed, stolen, etc.) thereby ensuring the integrity of the instant ticket game and its predetermined payout.

One issue with the above-described lottery system and instant lottery tickets is that there are substantial variations in the structures, configurations, and arrangements of the individual components of the inventory control numbers and barcodes for such instant lottery tickets. These variations most often occur on a jurisdictional basis and can occur on a manufacturer basis. This wide variety of the structures, configurations, and arrangements of the individual components of the inventory control numbers and barcodes for instant lottery tickets limits the types of systems that can be used to activate, validate, sell, use, and redeem such instant lottery tickets. For example, the above-described example instant lottery ticket books must be activated by dedicated lottery terminals prior to sale of any of the instant lottery tickets in such instant lottery ticket books. This limits the locations that such instant lottery tickets can be sold to the locations that have specific lottery terminals.

Various embodiments of the present disclosure provide products (such as instant lottery tickets) with multi-purpose indicators that have a more unified universal structure, configuration, and/or arrangement for a variety of different products (such as but not limited to for instant lottery tickets) that enable the products (such as instant lottery tickets) to be tracked and sold using a wider variety of different systems such as but not limited to distributor tacking systems and retailer or wholesaler point of sale (“POS”) systems. This substantially expands the locations that such different products (such as instant lottery tickets) can be sold, redeemed, and otherwise employed.

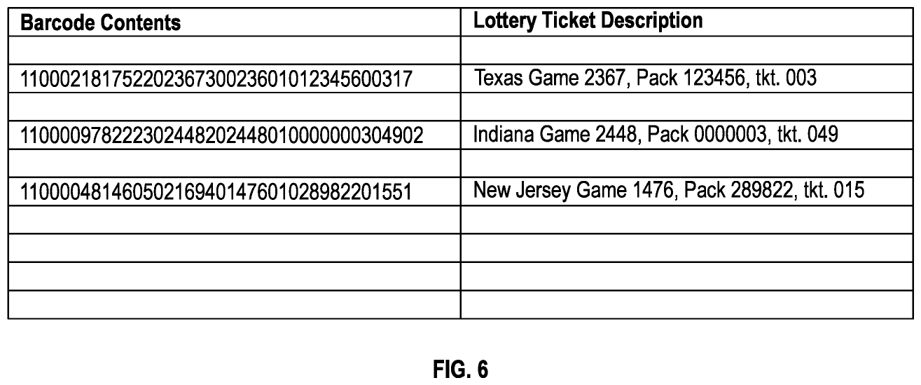

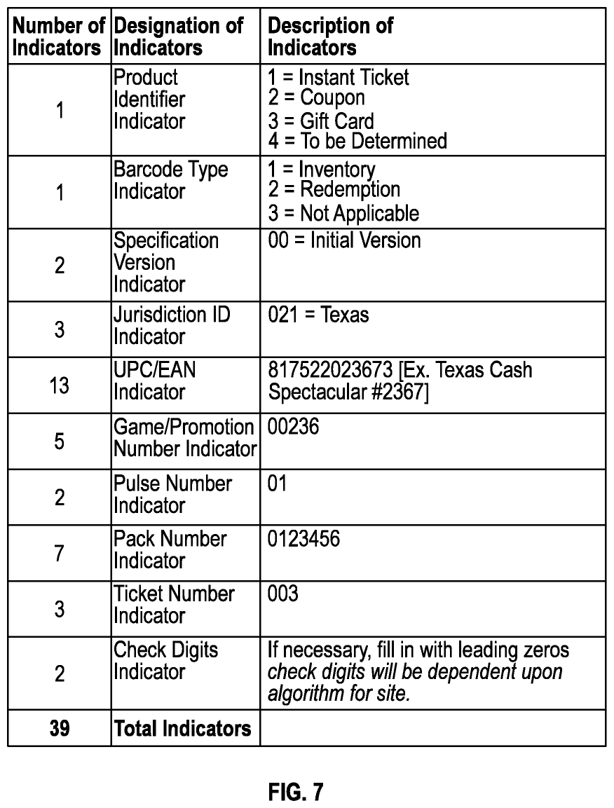

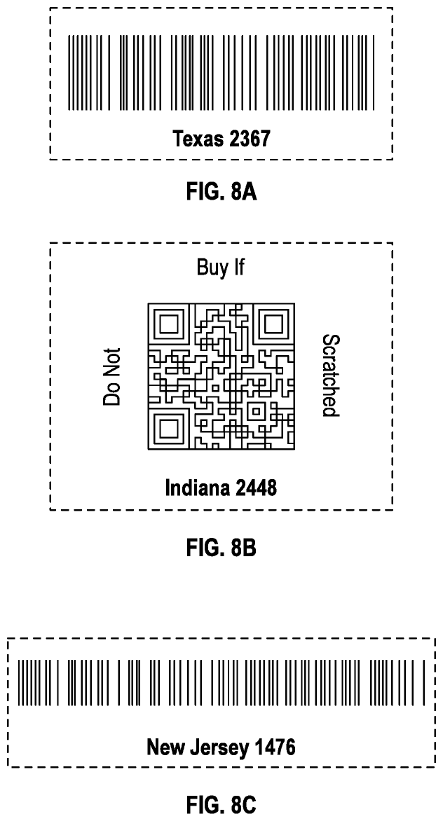

More specifically, FIGS. 6 and 8 illustrate multiple different example human and machine-readable embodiments of unified universal structures, configurations, and arrangements of multi-purpose indicators for products. FIG. 7 illustrates the multiple different indicator sets that are part of or form the multi-purpose indicator. In this example embodiment, the multi-purpose indicator includes the following indicator sets in the following order: (1) a product identifier indicator set, (2) a barcode type indicator set, (3) a specification version indicator set, (4) a jurisdiction identifier indicator set, (5) an UPC/EAN indicator set, (6) a game/promotion number indicator set, (7) a pulse number indicator set, (8) a book number indicator set, (9) a ticket number indicator set, and (10) a check digits indicator set. It should be appreciated that in various other embodiments, the order of two or more of the indicator sets can vary in accordance with the present disclosure. In these example embodiments, the products each include a substrate, human readable product-related information on the substrate, and one or more multi-purpose indicators on the substrate (such as printed or otherwise formed on the substrate). The substrate can be any suitable material and can be any suitable size. In these examples, the human readable product-related information on the substrate provides people with the ability to understand various information regarding the product based on the multi-purpose indicator on that product. In these example embodiments, the multi-purpose indicators include 39 specific indicators divided into 10 different indicator sets as further described below. In these example embodiments, the multi-purpose indicators include or represent essential data regarding the product.

As mentioned above, the product can be an instant lottery ticket, a pull-tab, a coupon, or a gift card. In the example embodiments of FIGS. 6, 7, and 8, the multi-purpose indicators are for instant lottery tickets. Such example embodiments are not meant to limit the present disclosure.

In this example embodiment, the first indicator set is a product identifier indicator set. In this example, the product identifier indicator set represents an identification of one of a plurality of different products such as an instant lottery ticket, a coupon, a gift card, or a pull-tab. In this example, the product identifier indicator set includes a single product identifier indicator. The product identifier indicator set enables the system processing the product (such as the instant lottery ticket) to quickly and easily determine the type of product being processed. Based on this identification of the product type, the system processing the product can easily determine which of the respective indicator sets (described below) are relevant or more relevant for that specific product type. For example, certain of the indicator sets are relevant for an instant lottery ticket but not relevant for a coupon. This indicator set is relevant for all products including instant lottery tickets, pull-tabs, coupons, and gift cards.

In this example embodiment, the second indicator set is a barcode type indicator set. In this example, the barcode type indicator set represents one of a plurality of different types of codes such as a sales code, a redemption code (or a portion thereof), or a not applicable code. In this example, the barcode type indicator set includes a single barcode type indicator. The barcode type indicator set enables the system processing the product (such as the instant lottery ticket) to quickly and easily identify or determine the high-level transaction that needs to be performed. This indicator set is relevant for all products including instant lottery tickets, pull-tabs, coupons, and gift cards.

In this example embodiment, the third indicator set is a specification version indicator set. In this example, the specification version indicator set represents one of a plurality of different types of versions of the multi-purpose indicator. It should be appreciated that other versions of the multi-purpose indicator can be implemented. This indicator will thus enable different systems to determine which version of the multi-purpose indicator is being employed and interpret the data correctly based on the specific version of the multi-purpose indicator. In this example, the specification version indicator set includes two specification indicators. The specification version indicator set enables the system processing the product (such as the instant lottery ticket) to quickly and easily identify or determine how the data in this multi-purpose indicator should be processed. This indicator set is relevant for all products including instant lottery tickets, pull-tabs, coupons, and gift cards.

In this example embodiment, the fourth indicator set is a jurisdiction identifier (ID) indicator set. In this example, the jurisdiction identifier indicator set represents one of a plurality of different jurisdictions (such a one of a plurality of states or a plurality of different countries) from which the product originated or was first sold or distributed. In this example, the jurisdiction identifier indicator set includes three jurisdiction identifier indicators. In this example, states are the different jurisdictions, and each different state has a different indicator (e.g., 021=Texas). The jurisdiction identifier indicator set enables the system processing the product (such as the instant lottery ticket) to quickly and easily identify or determine the jurisdiction from which the product first originated or was first sold or distributed. This jurisdiction indicator can be used by the processing system to know where to send the information contained in the multi-purpose indicator. The present disclosure contemplates that multi-jurisdictional products such as instant lottery tickets have unique jurisdiction identifiers. It should be appreciated that the quantity of indicators of this jurisdictional indicator can be increased if the actual quantity of jurisdictions for any one product extends beyond 999 jurisdictions. This indicator set is relevant for instant lottery tickets and pull-tabs and may be relevant for coupons and gift cards.

In this example embodiment, the fifth indicator set is a UPC/EAN indicator set. In this example, the UPC/EAN indicator set represents one of a plurality of different instant ticket games. In this example, the UPC/EAN indicator set includes thirteen UPC/EAN identifier indicators. The UPC/EAN indicator set enables the system processing the product (such as the instant lottery ticket) to quickly and easily determine the cost or price of the product such as the cost or price of the instant lottery ticket (similar to a price lookup for other goods). An example UPC/EAN indicator set is 817522023673 that represents a Texas Cash Spectacular ticket from game #2367. This indicator set is relevant for all products including instant lottery tickets, pull-tabs, coupons, and gift cards.

It should be appreciated that for recording retail sales the two primary barcode formats used are UPC and EAN. UPC stands for Universal Product Code (aka: UPC-A) and EAN stands for European Article Number (aka: EAN-13 or International Article Number). The UPC format is used primarily in the United States and Canada, and the EAN format is primarily used elsewhere around the world. The UPC format is 12 digits and the EAN format is 13 digits. The UPC was the original format for product barcodes in the 1970s. As demand for barcodes in Europe, Asia, and Australia grew, country codes were added to the front of the barcode number increasing the number of digits to 13 digits (which is why the EAN barcode includes one additional digit). The United States and Canada have a country code of zero that is not printed as part of the barcode nor is it entered in US and Canadian POS systems. Thus, a 12-digit UPC code can be converted to a 13-digit EAN by adding the country code of 0 to the beginning of the code. The fifth indicator set of the multi-purpose indicator of this example embodiment thus includes thirteen digits to account for both of these different types of codes.

In this example embodiment, the sixth indicator set is a game/promotion number indicator set. In this example, the game/promotion number indicator set represents one of a plurality of different games or promotions that identify one product from another product (such as one instant lottery ticket game or coupon from another instant lottery game or coupon). In this example, the game/promotion number identifier indicator set includes five game number indicators. In this example, the game number is 00236. The game/promotion number indicator set enables the system processing the product (such as the instant lottery ticket or coupon) to quickly and easily determine the game or promotion of or associated with the product. This indicator set is relevant for instant lottery tickets, pull-tabs, and coupons. This indicator can also be used to identify one gift card from another gift card in terms of product/company or financial value.

In this example embodiment, the seventh indicator set is a pulse number indicator set. Pulse used to describe the same physical item that has a different look. For example, in the instant lottery ticket industry, it would be used to describe a game where the first third of the total quantity of tickets in the game have one graphic appearance and the second and third portions of the tickets in the game have a different look. While tickets from each portion of the game would look different, the play symbols, prizes, and underlying prize structure for the game are consistent throughout all of the tickets in the game. Producing a game using different pluses makes tickets from the second or third pulse appear to be a new printing of tickets. For the gift card industry, a pulse can be used to identify different gift cards of the same value for a specific retail company or brand that have a different graphic appearance such as a “Happy Birthday” graphic, a “Happy Graduation” graphic, or a “Thank You!” graphic.

In this example, the pulse number indicator set represents one of a plurality of different pulses that the product (such as the instant lottery ticket) can be for or associated with. In this example, the pulse number identifier indicator set includes two pulse number indicators. In this example, the pulse number is 01. The pulse number indicator set enables the system processing the product (such as the instant lottery ticket) to quickly and easily identify or determine the specific pulse associated with a specific instant lottery ticket. This indicator set is relevant for instant tickets and can be relevant for coupons, pull-tabs, gift cards, and other products.

In this example embodiment, the eighth indicator set is a pack number indicator set. In some jurisdictions the word “book” is used interchangeably with pack to identify a specific grouping of instant tickets within an instant ticket game from another specific grouping of instant tickets in the same instant ticket game. In this example, the book number indicator set represents one of a plurality of different books that the product (such as the instant lottery ticket or unit) can be part of (e.g., different book units of the product). In this example, the book number indicator set includes seven book number indicators. In this example, the book number is 0123456. The book number indicator set enables the system processing the product (such as the instant lottery ticket or unit) to quickly and easily determine the book that the product (such as the instant lottery ticket or unit) is part of. It enables a system to process a group of instant tickets as an “entity” rather than having to process each individual ticket in the book separately. This indicator set is relevant for instant lottery tickets and pull-tabs and may be relevant for coupons and gift cards.

In this example embodiment, the ninth indicator set is a ticket number indicator set. In this example, the ticket number indicator set represents one of a plurality of different products (such as the instant lottery ticket or unit) of the identified book. In this example, the ticket number indicator set includes three ticket number indicators. In this example, the ticket number is 003. The ticket number indicator set enables the system processing the product (such as the instant lottery ticket or unit) to quickly and easily determine the product (such as the instant lottery ticket or unit) of the identified book. This indicator set is relevant for all products including instant lottery tickets, pull-tabs, coupons, and gift cards.

In this example embodiment, the tenth indicator set is a check digits indicator set. In this example, the check digits indicator set represents the results of a mathematical calculation that confirms the validity of all or a portion of the data of the indicator sets. In this example, the check digits indicator set includes two check digit indicators. The check digits indicator set enables the system processing the product (such as the instant lottery ticket) to quickly and easily verify the data of the rest of the indicators or indicator sets of the multi-purpose indicator. The check digits indicator set can be determined in any suitable manner based on the prior 37 indicators in the prior nine indicator sets. This indicator set is relevant for all products including instant lottery tickets, pull-tabs, coupons, and gift cards.

The multi-purpose indicators on the substrate of the products enables individual products such as individual instant lottery tickets to be activated or validated or books of products to be activated or processed using a wider variety of different systems such as but not limited to distributor systems, retailer or wholesaler POS systems, and other similar systems, which substantially expands the locations that such products such as instant lottery tickets, pull-tabs, coupons, and gift card can be activated, validated, sold, used, redeemed, and otherwise employed. For example, the multi-purpose indicators on the substrates of the instant lottery tickets enable the instant lottery tickets to be activated, sold, and redeemed at grocery store check-out lanes having POS systems. Likewise, the multi-purpose indicators on the substrates of gift cards enable the gift cards to be activated, sold, and redeemed at lottery ticket terminals.

In various embodiments, the individual stations of the POS systems can either locally interpret or parse the multi-purpose indicators on such products or can send the obtained data strings from the multi-purpose indicators to a central server where the central server interprets or parses the data string and sends back instructions signal to the individual stations. For example, a retail chain's POS system can record a transaction in chain's POS system and parse and send certain indicator data to a lottery system or a gift-card activation system. Because the multi-purpose indicators are contained in a single barcode, a retail clerk only needs to scan a single barcode to provide the processing system with all the information that would previously be present in at least two barcodes.

Employing products (such as instant lottery tickets) with the multi-purpose indicators of the present disclosure enables the above-described example instant lottery tickets that are provided in books that previously needed to be activated on the book level as described above to be activated on the ticket level such as by POS systems communicating with a lottery system. This is because the multi-purpose indicator enables a retail POS system to identify the item, determine it is an instant ticket (in this case) and to send the appropriate information to the appropriate lottery system since one of the multiple indicators identifies the jurisdiction.

Employing products (such as instant lottery tickets) with the multi-purpose indicators of the present disclosure enables the above-described example instant lottery tickets to be validated and redeemed on the ticket level such as by POS systems. The multi-purpose indicator (such as in the form of a barcode) enables a retail clerk to be able to scan the indicator such (as the barcode) to enable the system to determine based upon the data in the indicator (such as the barcode) that addition data found in the play area under the scratch-off coating must be entered into the POS system to provide all the information necessary to validate a ticket.

The multi-purpose indicators are readable by multiple different systems such as, but not limited to, POS systems (and particularly by flat scanners and/or handheld barcode readers of such systems), lottery terminals (such as by via handheld barcode readers and/or built-in barcode readers), and warehouse or manufacturing facility scanners (such as barcode scanners). In various embodiments, the systems such as the POS systems can read (such as by scanning) the multi-purpose indicator of a product and parse the different indicator sets to determine the relevant information needed for processing that specific type of product to perform a specific activity). In various embodiments, the systems such as the POS systems will also use certain of the indicator sets (such as the first product identifier indicator set, the fifth indicator set, and the tenth check digits indicator set) and will selectively use other of the indicator sets based on the first product identifier indicator set that identifies the specific type of product.

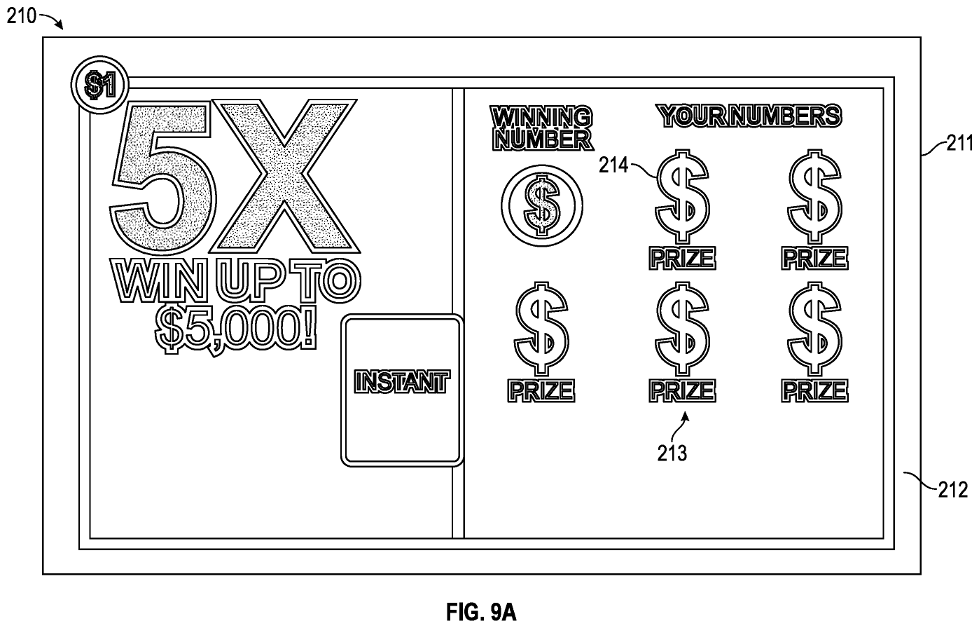

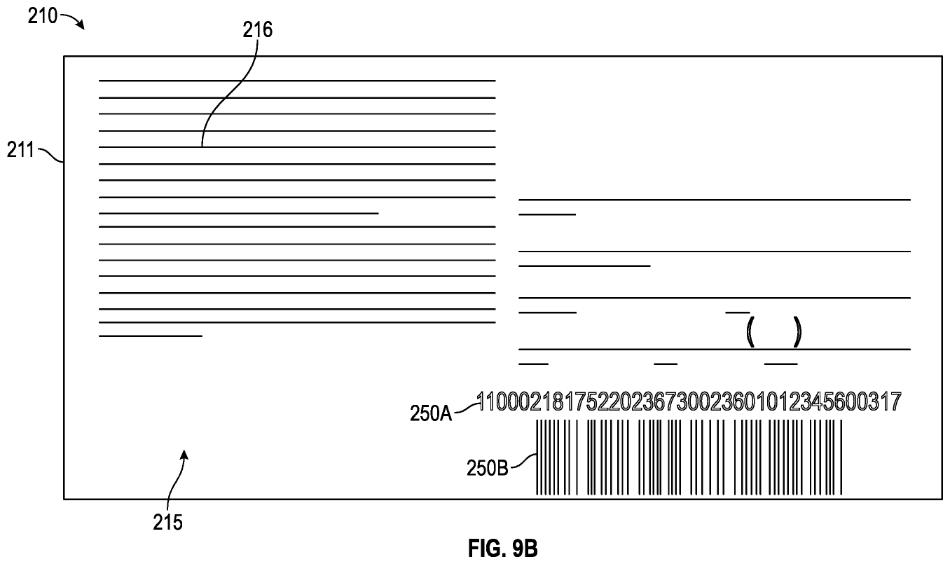

Turning now to FIGS. 9A and 9B, an example single game instant lottery ticket 210 includes: (1) a ticket substrate 211; (2) a front surface 212 of the ticket substrate 211; (3) a predefined scratch-off area 213 defined on the front surface 212; (4) a SOC 214 covering variable lottery game indicia (not shown) printed on the predefined scratch-off area 213; (6) a back surface 215 of the ticket substrate 211; (7) information 216 printed on the back surface 215; and (8) the multi-purpose indicators 250A and 250B printed on the back surface 215. The multi-purpose indicator 250A is in a human readable format and the multi-purpose indicator 250B is in a machine-readable format. In alternative embodiments, the multi-purpose indicators 250A and 250B are printed on the front surface 212. In this example embodiment, the multi-purpose indicator includes: a product identifier indicator set, a barcode type indicator set, a specification version indicator set, a jurisdiction identifier indicator set, an UPC/EAN indicator set, a game/promotion number indicator set, a pulse number indicator set, a book number indicator set, a ticket number indicator set, and a check digits indicator set, as explained above.

It should be appreciated from the above that various embodiments of the present disclosure provide a product including a substrate having a front surface and a back surface, and a multi-purpose indicator on one of the front surface and the back surface, the multi-purpose indicator comprising: a product identifier indicator set, a barcode type indicator set, a specification version indicator set, a jurisdiction identifier indicator set, an UPC/EAN indicator set, a game/promotion number indicator set, a pulse number indicator set, a book number indicator set, a ticket number indicator set, and a check digits indicator set. In various such embodiments, depending on the specific type of the product (i.e., depending on whether the product is an instant lottery ticket, a gift card, a coupon, or a pull-tab) one or more of the jurisdiction identifier indicator set, the UPC/EAN indicator set, the game/promotion number indicator set, the pulse number indicator set, the book number indicator set, and the ticket number indicator set can be not relevant to the product. In other words, even though multi-purpose indicator for a product will include all of these sets, one or more of these can sets can be irrelevant for that specific product. For example, for an instant lottery ticket, the pulse number indicator set may not be relevant to the specific instant lottery ticket. For example, for a coupon, the book number indicator set may not be relevant to the coupon. For example, for a gift card, the jurisdiction indicator set, or the pulse number indicator set may not be relevant to the gift card.

It should be appreciated that various embodiments the multi-purpose indicator (such as the barcode) enables instant lottery ticket validation. Typically, all or a portion of the information required to enable an instant ticket to be verified as a winning instant ticket (i.e., validated) is printed on the front surface of the lottery ticket and is covered with the SOC coating to protect the integrity of the information. Lotteries typically require that this information to stay hidden under the SOC until a person buys the ticket and plays the game. This information is typically printed in the form of a barcode and a portion can be printed in a human-readable form. Once the player has removed the relevant portion of the SOC from the lottery ticket to play the game, the player may expose the validation barcode to enable verification in a lottery ticket checking device, a mobile phone with a specific application, or to facilitate validation by a retail clerk.

Configuring this information with other indicators as described above as part of a multi-purpose indicator (such as a barcode) increases the quantity of locations that can be authorized to provide pay-outs for winning lottery tickets on behalf of a lottery. This eliminates the need for the transaction to occur using a dedicated lottery terminal. For example, this can enable a winning instant ticket to be validated in a checkout lane at a grocery store rather than being limited to a service desk where the lottery terminal is located at such a store.

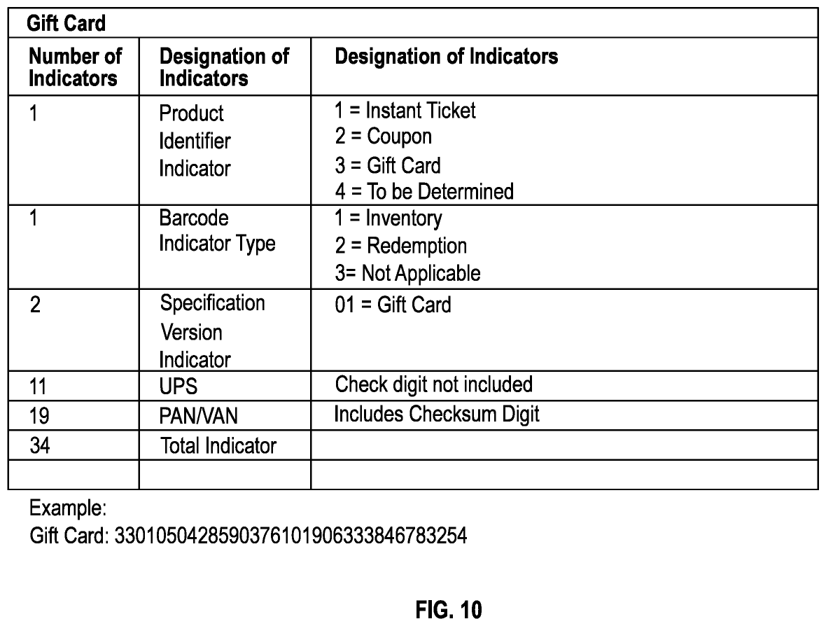

FIG. 10 illustrates an alternative example embodiment of the multi-purpose indicator for a gift card wherein multiple different indicator sets form the multi-purpose indicator. In this example embodiment, the multi-purpose indicator includes the following indicator sets in the following order: (1) a product identifier indicator set, (2) a barcode type indicator set, (3) a specification version indicator set, (4) a UPC identifier indicator set, and (5) a PAN/VAN identifier indicator set. It should be appreciated that in various other embodiments, the order of two or more of the indicator sets can vary in accordance with the present disclosure. In this example embodiment, the product in the form of the gift card can include a substrate, human readable product-related information on the substrate, and one or more multi-purpose indicators on the substrate (such as printed or otherwise formed on the substrate). The substrate can be any suitable material and can be any suitable size. In this example, the human readable product-related information on the substrate provides people with the ability to understand various information regarding the gift card based on the multi-purpose indicator on that gift card. In this example embodiment, the multi-purpose indicators include 17 specific indicators divided into 5 different indicator sets. In this example embodiments, the multi-purpose indicators include or represent essential data regarding the gift card.

In this example embodiment, the first, second, third, and fourth identifier indicator sets are the same as the above-described identifier indicator sets and are thus not described herein for brevity except that the UPC identifier indicator set in this example does not includes a check digit.

In this example embodiment, the fifth identifier indicator set is a PAN/VAN identifier indicator set. In this example, the PAN/VAN identifier indicator set represents a primary account number/virtual account number used to uniquely identify an account and also provide data for routing of transactions associated with that account. In this gift card example, the PAN/VAN indicator set includes nineteen PAN/VAN identifier indicators. The 19 digits include an 8-9-digit IIN (issuer identification number), followed by a unique 9-10-digit account number, and then a single check digit. The PAN/VAN identifier indicator set enables the system processing the gift card to quickly and easily identify or determine the gift card and the source of the gift card. It should be appreciated that the quantity of identifier indicators of this PAN/VAN identifier indicator set can be increased if needed.

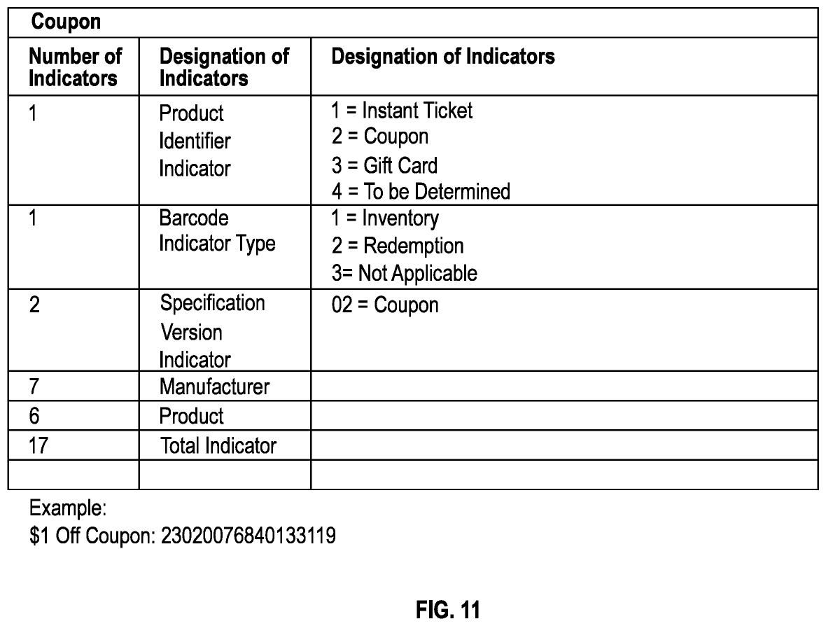

FIG. 11 illustrates an alternative example embodiment of the multi-purpose indicator for a coupon for a product wherein multiple different indicator sets form the multi-purpose indicator. In this example embodiment, the multi-purpose indicator includes the following indicator sets in the following order: (1) a product identifier indicator set, (2) a barcode type indicator set, (3) a specification version indicator set, (4) a manufacturer indicator set, and (5) a product indicator set. It should be appreciated that in various other embodiments, the order of two or more of the indicator sets can vary in accordance with the present disclosure. In this example embodiment, the coupon can include a substrate, human readable coupon-related information on the substrate, and one or more multi-purpose indicators on the substrate (such as printed or otherwise formed on the substrate). The substrate can be any suitable material and can be any suitable size. In this example, the human readable product-related information on the substrate provides people with the ability to understand various information regarding the coupon based on the multi-purpose indicator on that coupon. In this example embodiment, the multi-purpose indicator includes 17 specific indicators divided into 5 different indicator sets. In this example embodiments, the multi-purpose indicator includes or represent essential data regarding the coupon.

In this example embodiment, the first, second, and third indicator sets are the same as the above-described indicator sets and are thus not described herein for brevity.

In this example embodiment, the fourth indicator set is a manufacturer indicator set. In this example, the manufacturer indicator set represents one of a plurality of different manufacturers from which the coupon originated. In this example, the manufacturer indicator set includes seven manufacturer identifier indicators. The manufacturer identifier indicator set enables the system processing the coupon to quickly and easily identify or determine the manufacturer from which the coupon first originated or was first sold or distributed. This manufacturer indicator can be used by the processing system to know where to send the information contained in the multi-purpose indicator. It should be appreciated that the quantity of indicators of this manufacturer indicator can be increased if the actual quantity of manufacturers extends beyond 9,999,999 manufacturers. In this example embodiment, the fifth indicator set is a product indicator set. In this example, the product indicator set represents one of a plurality of different products which the coupon is for. In this example, the product indicator set includes six product identifier indicators. The product indicator set enables the system processing the coupon to quickly and easily determine the identification of the product that the coupon is associated with.

Various changes and modifications to the present embodiments described herein will be apparent to those skilled in the art. Such changes and modifications can be made without departing from the spirit and scope of the present subject matter and without diminishing its intended technical scope. It is therefore intended that such changes and modifications be covered by the appended claims.

The claims are as follows:

1. A product comprising:
a substrate having a front surface and a back surface; and
a multi-purpose indicator on one of the front surface and the back surface, the multi-purpose indicator comprising: a product identifier indicator set, a barcode type indicator set, a specification version indicator set, a jurisdiction identifier indicator set, an UPC/EAN indicator set, a game/promotion number indicator set, a pulse number indicator set, a book number indicator set, a ticket number indicator set, and a check digits indicator set.

2. The product of claim 1, wherein the multi-purpose indicator is in a machine-readable format.

3. The product of claim 1, wherein the multi-purpose indicator is in a human readable format and the multi-purpose indicator is in a machine-readable format.

4. The product of claim 1, which is an instant lottery ticket.

5. The product of claim 1, which is an instant lottery ticket, wherein the front surface of the substrate comprises a predefined scratch-off area and variable lottery game indicia printed on the predefined scratch-off area, and which further comprises a scratch-off-coating covering the variable lottery game indicia.

6. The product of claim 1, wherein: (a) the product identifier indicator set represents an identification of one of a plurality of different products; (b) the barcode type indicator set represents one of a sales code, a portion of a redemption code, and a not applicable code; (c) the specification version indicator set represents one of a plurality of different types of versions; (d) the jurisdiction identifier indicator set represents one of a plurality of different jurisdictions from which the product originated or was first sold or distributed; (e) the UPC/EAN indicator set represents one of a plurality of different UPC/EAN codes; (f) the game/promotion number indicator set represents one of a plurality of different games or promotions; (g) the pulse number indicator set represents one of a plurality of different pulses associated with the product; (h) the book number indicator set represents one of a plurality of different book units of the product; (i) the ticket number indicator set represents one of a plurality of different units of the product; and (j) the check digits indicator set represents a confirmation that data in the multi-purpose indicator is correct.

7. The product of claim 6, wherein: (a) the product identifier indicator set comprises one product identifier indicator; (b) the barcode type indicator comprises one barcode type indicator; (c) the specification version indicator set comprises two specification indicators; (d) the jurisdiction identifier indicator set comprises three jurisdiction identifier indicators; (e) the UPC/EAN indicator set comprises thirteen UPC/EAN identifier indicators; (f) the game/promotion number indicator set comprises five game number indicators; (g) the pulse number indicator set comprises two pulse number indicators; (h) the book number indicator set comprises seven book number indicators; (i) the ticket number indicator set comprises three ticket number indicators; and the check digits indicator set comprises two check digit indicators.

8. The product of claim 1, wherein: (a) the product identifier indicator set comprises one product identifier indicator; (b) the barcode type indicator comprises one barcode type indicator; (c) the specification version indicator set comprises two specification indicators; (d) the jurisdiction identifier indicator set comprises three jurisdiction identifier indicators; (e) the UPC/EAN indicator set comprises thirteen UPC/EAN identifier indicators; (f) the game/promotion number indicator set comprises five game number indicators; (g) the pulse number indicator set comprises two pulse number indicators; (h) the book number indicator set comprises seven book number indicators; (i) the ticket number indicator set comprises three ticket number indicators; and (j) the check digits indicator set comprises two check digit indicators.

9. An instant lottery ticket product comprising:
a substrate having a front surface and a back surface, the front surface of comprising a predefined scratch-off area;
variable lottery game indicia printed on the predefined scratch-off area;
a scratch-off-coating covering the variable lottery game indicia; and
a multi-purpose indicator in a machine-readable format on the back surface of the substrate, the multi-purpose indicator comprising: a product identifier indicator set, a barcode type indicator set, a specification version indicator set, a jurisdiction identifier indicator set, an UPC/EAN indicator set, a game/promotion number indicator set, a pulse number indicator set, a book number indicator set, a ticket number indicator set, and a check digits indicator set.

10. The instant lottery ticket product of claim 9, wherein the multi-purpose indicator is also in a human readable format on the back surface of the substrate.

11. The instant lottery ticket product of claim 9, wherein: (a) the product identifier indicator set represents an identification associated with the instant lottery ticket product type; (b) the barcode type indicator set represents one of an sales code, a portion of a redemption code, and a not applicable code; (c) the specification version indicator set represents one of a plurality of different types of versions; (d) the jurisdiction identifier indicator set represents one of a plurality of different jurisdictions from which the product originated or was first sold or distributed; (e) the UPC/EAN indicator set represents one of a plurality of different UPC/EAN codes; (f) the game/promotion number indicator set represents one of a plurality of different games; (g) the pulse number indicator set represents one of a plurality of different pulses; (h) the book number indicator set represents one of a plurality of different books; (i) the ticket number indicator set represents one of a plurality of different products; and (j) the check digits indicator set represents a mathematical confirmation that data in the multi-purpose indicator is correct.

12. The instant lottery ticket product of claim 11, wherein: (a) the product identifier indicator set comprises one product identifier indicator; (b) the barcode type indicator comprises one barcode type indicator; (c) the specification version indicator set comprises two specification indicators; (d) the jurisdiction identifier indicator set comprises three jurisdiction identifier indicators; (e) the UPC/EAN indicator set comprises thirteen UPC/EAN identifier indicators; (f) the game/promotion number indicator set comprises five game number indicators; (g) the pulse number indicator set comprises two pulse number indicators; (h) the book number indicator set comprises seven book number indicators; (i) the ticket number indicator set comprises three ticket number indicators; and (l) the check digits indicator set comprises two check digit indicators.

13. The instant lottery ticket product of claim 9, wherein: (a) the product identifier indicator set comprises one product identifier indicator; (b) the barcode type indicator comprises one barcode type indicator; (c) the specification version indicator set comprises two specification indicators; (d) the jurisdiction identifier indicator set comprises three jurisdiction identifier indicators; (e) the UPC/EAN indicator set comprises thirteen UPC/EAN identifier indicators; (f) the game/promotion number indicator set comprises five game number indicators; (g) the pulse number indicator set comprises two pulse number indicators; (h) the book number indicator set comprises seven book number indicators; (i) the ticket number indicator set comprises three ticket number indicators; and (j) the check digits indicator set comprises two check digit indicators.

14. A product comprising:
a substrate having a front surface and a back surface; and
a multi-purpose indicator on one of the front surface and the back surface, the multi-purpose indicator comprising: a product identifier indicator set, a barcode type indicator set, a specification version indicator set, a jurisdiction identifier indicator set, an UPC/EAN indicator set, a game/promotion number indicator set, a pulse number indicator set, a book number indicator set, a ticket number indicator set, and a check digits indicator set,
wherein one of the jurisdiction identifier indicator set, the game/promotion number indicator set, the book number indicator set, and the ticket number indicator set are not relevant to the product.

15. The product of claim 14, which is an instant lottery ticket and wherein the pulse number indicator set is not relevant to the instant lottery ticket.

16. The product of claim 14, which is an instant lottery ticket, wherein the front surface of the substrate comprises a predefined scratch-off area and variable lottery game indicia printed on the predefined scratch-off area, and which further comprises a scratch-off-coating covering the variable lottery game indicia.

17. The product of claim 14, which is a coupon and wherein the jurisdiction indicator is not relevant to the coupon.

18. The product of claim 14, which is a gift card and wherein the jurisdiction indicator is not relevant to the gift card.

19. The product of claim 14, wherein: (a) the product identifier indicator set represents an identification of one of a plurality of different products; (b) the barcode type indicator set represents one of a sales code, a portion of a redemption code, and a not applicable code; (c) the specification version indicator set represents one of a plurality of different types of versions; (d) the jurisdiction identifier indicator set represents one of a plurality of different jurisdictions from which the product originated or was first sold or distributed; (e) the UPC/EAN indicator set represents one of a plurality of different UPC/EAN codes; (f) the game/promotion number indicator set represents one of a plurality of different games or promotions; (g) the pulse number indicator set represents one of a plurality of different pulses associated with the product; (h) the book number indicator set represents one of a plurality of different books; (i) the ticket number indicator set represents one of a plurality of different products; and (j) the check digits indicator set represents a mathematical confirmation that data in the multi-purpose indicator is correct.

20. The product of claim 14, wherein: (a) the product identifier indicator set comprises one product identifier indicator; (b) the barcode type indicator comprises one barcode type indicator; (c) the specification version indicator set comprises two specification indicators; (d) the jurisdiction identifier indicator set comprises three jurisdiction identifier indicators; (e) the UPC/EAN indicator set comprises thirteen UPC/EAN identifier indicators; (f) the game/promotion number indicator set comprises five game number indicators; (g) the pulse number indicator set comprises two pulse number indicators; (h) the book number indicator set comprises seven book number indicators; (i) the ticket number indicator set comprises three ticket number indicators; and (j) the check digits indicator set comprises two check digit indicators.
